(19) United States
(12) Patent Application Publication
(10) Pub. No.: US 2005/0125468 A1
(43) Pub. Date: Jun. 9, 2005

(54) System and method of testing and evaluating mathematical functions

(75) Inventor: Robert F. Enenkel, Markham (CA)

Correspondence Address: Jerry W. Herndon;Intenational Business Machines, Intellectual Property Law, Dept. T81/Bldg. 503, PO Box 12195, Research Triangle Park, NC, 27709, US

(73) Assignee: International Business Machines Corporation, Armonk, NY (US)

(21) Appl. No.: 11/001,205

(22) Filed: Dec. 1, 2004

(30) Foreign Application Priority Data
Dec. 3, 2003 (CA) 2,452,274

(51) Int. Cl. G06F 1/00

(52) U.S. Cl. 708/200

(57) ABSTRACT

The present invention provides a system and method for systematic random testing of single/double-precision, one/two-variable or scalar/vector mathematical functions against a known higher precision reference mathematical library or to the result of an arbitrary precision mathematical package. The systematic random testing of mathematical functions is performed across the entire floating-point range or a test interval defined therein, including denormalized numbers with random test arguments appropriately distributed over the test interval. By ensuring the density of coverage of random test arguments across the test interval by comparison against a statistical model and identifying the exception behavior of the mathematical function, an accurate picture of the performance and accuracy of the mathematical function can be assessed.

### FIELD OF INVENTION

The present invention relates to the field of testing and evaluating mathematical functions, for example, those contained in mathematical libraries that may be supplied as part of computer language compilers or operating systems.

### BACKGROUND

Mathematical libraries are extensively used in computer software to implement common mathematical functions. These mathematical libraries are often supplied as part of language compilers or operating systems to implement a range of mathematical functions such as division, multiplication, squares, powers, sin, cos and tan to more complex mathematical operations. The mathematical libraries provide computer programmers a convenient mechanism of executing a variety of mathematical functions simply by calling the desired mathematical function and providing the appropriate input arguments for each variable of the mathematical function (i.e. division represented as x/y is a two variable mathematical function requiring two input arguments). The mathematical function in return provides a result. However, the accuracy of the result and the speed at which it is produced is dependent on the mathematical library selected and how that particular mathematical function is implemented within the mathematical library. The results provided by many mathematical functions, and in particular floating-point based mathematical functions, are typically only approximations of the actual result. The reason that the mathematical functions produce approximations as opposed to precise results is either because the exact result is not representable in the floating-point number system, or because the computations required to calculate the exact result would be extremely costly in processing time. As such, trade-offs are often made in the design of mathematical libraries and mathematical functions and they therefore must be selected depending on the performance and accuracy required by the target application.

Mathematical libraries are typically furnished with limited information on the speed and accuracy of the mathematical function, if any. Even if this information is available, there are no consistent baselines against which the mathematical libraries are assessed. For example, the system or processor on which the mathematical library is tested may not adequately reflect the performance that will result in the target system or processor on which it will eventually be used. In addition, the methods by which the performance data is collected is not standardized. The common method used in the art to evaluate the performance of mathematical functions is accomplished by selection of a few thousand random arguments over a limited test interval (e.g. three thousand uniformly distributed random arguments selected between 0 and 10). However, this can result in a lack of small numbers being selected in the test interval, particularly when dealing with a floating-point number system. The resulting evaluation of the mathematical function, based on uniformly distributed numbers does not provide an accurate reflection of the density of floating-point numbers relative to each exponent. It therefore can be difficult for a programmer to evaluate the performance of a mathematical library based upon the limited information available. The ability to assess mathematical libraries and their mathematical functions in a consistent manner, and provide confidence in the coverage of the testing, is an area that requires improvement.

### SUMMARY OF INVENTION

In an exemplary embodiment, the present invention provides a system and method for systematic random testing of single/double-precision, one/two-variable or scalar/vector mathematical functions against a known higher precision reference mathematical library or to the result of an arbitrary precision mathematical package. The systematic random testing of a mathematical function is performed across the entire floating-point range or a test interval defined therein, including denormalized numbers with random test arguments appropriately distributed over the test interval. By ensuring the density of coverage of random test arguments across the test interval against a statistical model and identifying the exception behavior of the mathematical function, an accurate picture of the performance and accuracy of the mathematical function can be assessed.

In accordance with one aspect of the present invention, there is provided a system of testing and evaluating the accuracy of a mathematical function for use in computer software in relation to a reference mathematical function over a test interval, the system comprising: an argument generation module for generating a piecewise uniform and overall exponential distribution of random test arguments for each floating-point exponent within the test interval; a computation module interfacing with the mathematical function to obtain a first set of results and the reference mathematical function to obtain a second set of results based on the random test arguments generated by the argument generation module; and an evaluation module for analyzing the first set of results with the second set of results for providing an indication of accuracy of the mathematical function.

In accordance with another aspect of the present invention, there is a provided a method of testing and evaluating the accuracy of a mathematical function to a known mathematical function over a test interval, the method comprising: (a) generating a set of piecewise uniformly and exponentially distributed random test arguments for each floating-point exponent within the test interval; (b) obtaining a first set of results from the mathematical function using the random test arguments; (c) obtaining a second set of results from reference mathematical function using the random test arguments; and (d) comparing said first set of results to said second set of results to determine the accuracy of the mathematical function.

### BRIEF DESCRIPTION OF DRAWINGS

FIG. 1 is a system diagram according to an embodiment of the invention;

FIG. 2 is a flow diagram of a method according to an embodiment of the invention; and

FIG. 3 is a diagram of a computer system useful in implementing the embodiments of the invention; and

FIG. 4 is an excerpt from a report generated according to an embodiment of the invention.

### DETAILED DESCRIPTION

Testing a mathematical function ideally involves exhaustively testing the mathematical function across all possible test arguments. Although this is feasible for some single-precision (e.g. 32-bit) floating-point mathematical functions, for double-precision (e.g. 64-bit) functions this is practically infeasible in terms of the time and processing required to adequately cover all arguments.

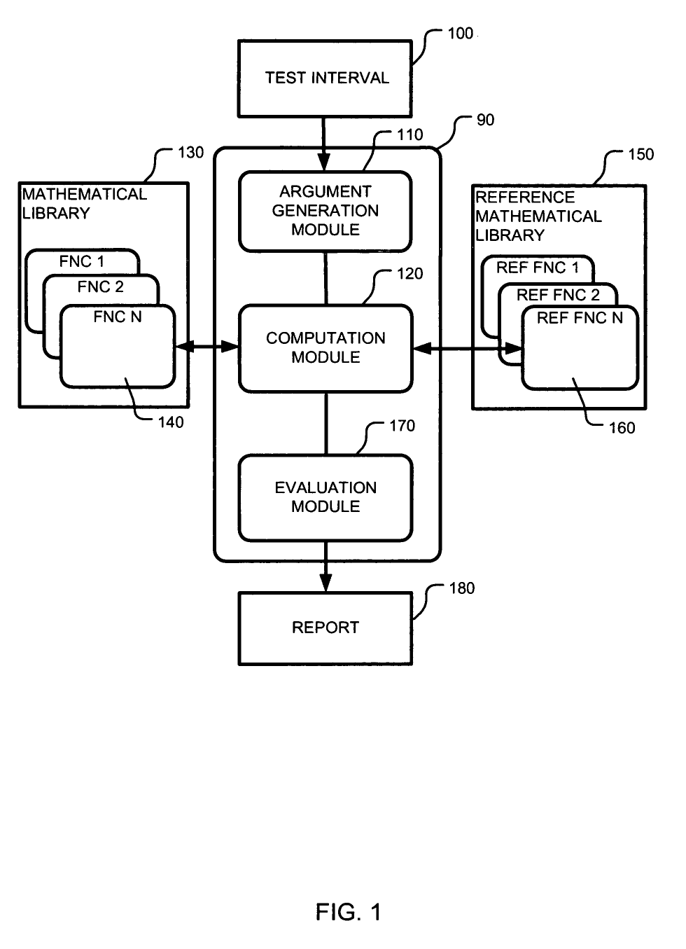

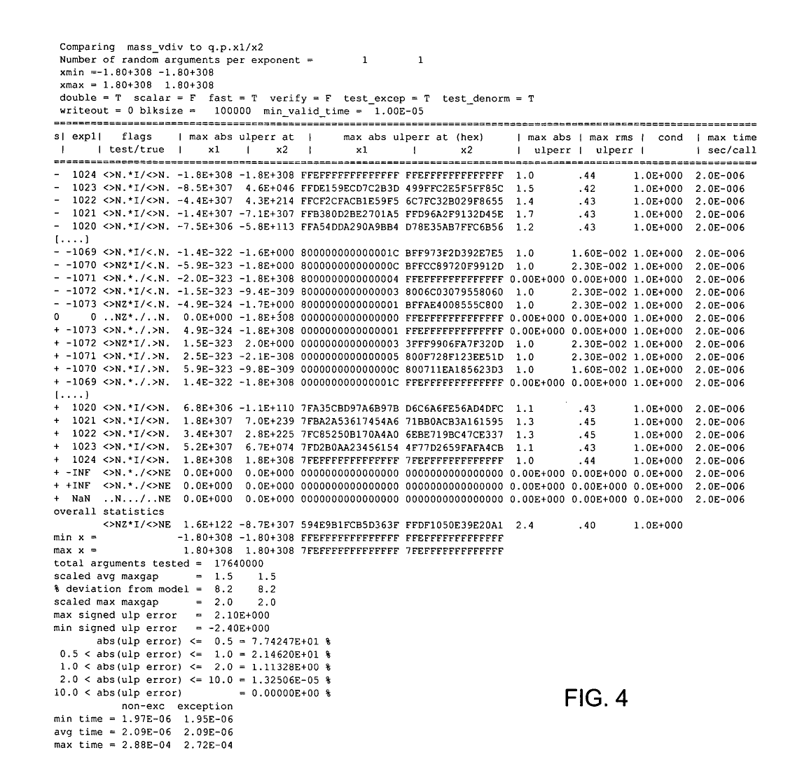

FIG. 1 illustrates a system 90 for evaluating the performance and accuracy of a mathematical function from a mathematical library according to an embodiment of the invention. In order to evaluate a mathematical function, such as mathematical functions FNC1 to FNC N 140 contained in a mathematical library 130, a test interval 100 defining the maximum and minimum input arguments of interest for the variables of the mathematical function must be selected. The test interval 100 is selected based upon the evaluation requirements of the user and the testing constraints of FNC N 140. Multiple test intervals 100 may be defined for FNC N 140 based upon multiple intervals of interest with each interval being evaluated individually. The test interval 100 is provided as input into the system 90 together with other external configuration parameters (described in relation to FIG. 4). Random test arguments are generated by an argument generation module 110 based upon the test interval 100. For example, for each input variable of a given mathematical function (i.e. x and y in xdivy or x/y), and for each floating-point exponent in the test interval 100, the requested number of uniformly distributed random numbers between 0.5 and 1 are generated. These random numbers are used as the fractions of the floating-point numbers used as test arguments with that exponent. This results in a piecewise uniform, but overall exponential distribution of test arguments. This distribution of arguments matches the distribution of the floating-point number system itself for each exponent. In other words, a piecewise uniform and overall exponential distribution of random test arguments for each floating-point exponent within the test interval are generated. Therefore, the number of random test arguments in any given region of the test interval 100 is proportional to the number of floating-point numbers in that region. Thus, neither small nor large values are disproportionately represented as is typically the case when a fixed number of uniformly randomly distributed test arguments are selected over a test interval covering more than one order of magnitude, for example 1000 numbers chosen between 0 and 10.

If the test interval 100 includes denormalized numbers (IEEE 754 Standard for Binary Floating-Point Arithmetic, incorporated here in by reference), they are equally represented by considering each order of magnitude of denormalized numbers to have an exponent value below that of the smallest normal exponent in the floating-point number system.

As part of the argument generation module 110, analysis of the coverage of the randomly generated test arguments across the test interval 100 is performed by comparison to known statistical models. For large n, the statistical distribution of the maximum gap g between two adjacent values, when n−1 values are uniformly randomly chosen between 0 and 1, can be approximated by the probability density function defined in Equation 1.
P(g>x)=(1−e^{-nx})ⁿ EQ. 1

The peak of P(g>x) can be shown to occur at x=(log n)/n, so the typical maximum gap can be expected to be (log n)/n.

For n−1 uniformly spaced (not random) numbers between 0 and 1, the gap is 1/n, which is a lower bound for the corresponding value for random numbers. Therefore, the scaled gap size obtained by multiplying the gap size by n is a useful measure of the coverage of the interval by the random test arguments. For large n, the probability density function of Eq. 1, predicts that the typical scaled maximum gap size should behave like log n.

To apply this model to the random arguments chosen by the test environment, the interval (0,1) in the model is mapped to the floating-point fraction range (0.5,1).

The random test arguments generated by the argument generation module 110 are passed to and processed by a computation module 120. The computation module 120 calls a test mathematical function such as test mathematical function N (FNC N) 140, from the mathematical library 130, and provides the random test arguments for each variable of FNC N 140. The calculated result from FNC N 140, is returned to the computation module 120 and provided to an evaluation module 170. Likewise, the same arguments are provided by the computation module 120 to a reference mathematical function N (REF FNC N) 160 from a reference mathematical library 150 and the results provided to an evaluation module 170. The random test arguments are provided either individually in a loop (for a scalar mathematical function), or as a vector (in the case of a vector mathematical function). The time for a number of repetitions of this calling process is measured and divided by the number of calls, providing a time per call metric. The number of repetitions is adjusted dynamically to ensure that the total time measured is large enough to reduce errors caused by the inherent noise of the timing process.

The reference mathematical library 150 and REF FNC N 160 are chosen to provide known higher accuracy results than the mathematical library 130 and FNC N 140. For example, REF FNC N 160 would be from a quad-precision mathematical reference library 150 while FNC N 140 would be from a double-precision mathematical library 130. Alternatively, the system 90 provides an interface (not shown) to a symbolic/numeric package, such as Mathematica™, allowing the REF FNC N 160 to be computed to any required precision when no higher precision reference library is available. For example, trigonometric mathematical functions with large arguments, whose accuracy depends on accurate range reduction beyond the capability of even quad-precision arithmetic would require such an interface to evaluate FNC N 140.

The values returned by the test mathematical function N 140 and reference mathematical function N 160 are compared by the evaluation module 170. In addition, the exception behavior to inputs such as ±∞ and NaN (Not a Number, IEEE 754 previously referred) inputs is also computed by the computation module 120 for FNC N 140 and REF FNC N 160. If one of REF N 140 or REF FNC N 160 returns an exception, and the other does not, or returns a different exception, this information is stored and provided to the evaluation module 170 as well.

The evaluation module 170 determines, on an individual floating-point exponent basis, parameters such as the argument(s) at which the maximum observed error occurred (e.g. in both decimal and hex), the maximum absolute error in units in last place (ulps), the maximum root-mean-squared (rms) error in ulps and the time per call metric as described above. The results of the accuracy testing, timing, and exception behavior analysis are presented in a report 180. An example of a condensed report is shown in FIG. 4.

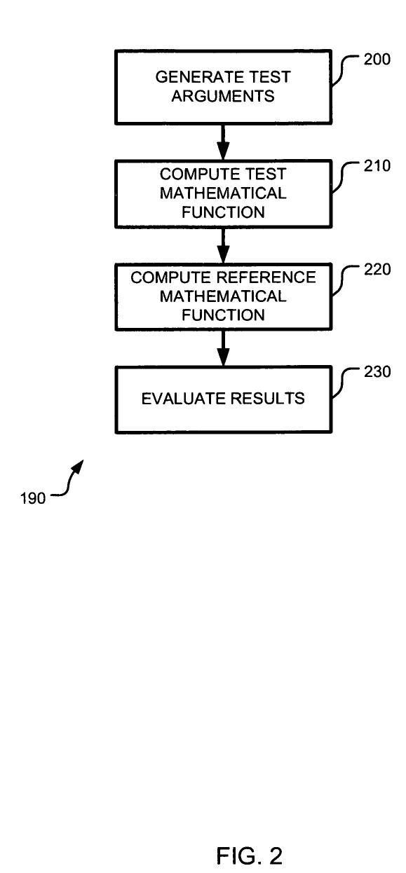

FIG. 2 illustrates a method 190 for testing and evaluating the performance and accuracy of a mathematical function (e.g. one of FNC 1 to FNC N 160 from FIG. 1) from the mathematical library 130 according to an embodiment of the invention. Random test arguments are generated at step 200 by the argument generation module 110 based upon the test interval 100. The arguments are generated in a piecewise uniform and overall exponential distribution of random test arguments for each floating-point exponent within the test interval. This distribution of arguments matches the distribution of the floating-point number system itself for each exponent as previously discussed.

The test mathematical function that is to be evaluated, such as FNC N 140, is then called using the random test arguments generated by the argument generation module 110, by the computation module 120 at a compute test function step 210 for each variable of the FNC N 160. Likewise, the reference mathematical function N 160, is called using the same random test arguments by computation module 120 at the compute reference function step 220. Steps 210 and 220 also include the collection by the computation module 120 of the results from the mathematical function (FNC N 140 and REF FNC N 160) and storage of performance statistics, as previously discussed, for evaluation by the evaluation module 170. The method 190 continues to an evaluation of the results process at step 230, which is executed by the evaluation module 170. From step 230 a report can be produced summarizing the results of the method 190, a condensed example of which is shown in FIG. 4.

The report shown in FIG. 4, was generated for a 2-variable, vector division mathematical function (vdiv). A listing of the configuration parameters selected, the test and reference mathematical functions selected, summarized results of the performance of the test mathematical function on a per floating-point exponent basis (only selected results are shown) and the overall statistics generated by the system 90 are presented in the report. The initial lines of the report shown in FIG. 4, identify the configuration parameters selected. In this example, the test mathematical function and reference mathematical function selected are identified, followed by the density of testing requested (1 argument in each variable per exponent), the test interval (the entire floating-point range for both variables), and the values of various control flags that define the configuration parameters. These flags, for example, represent enabling double-precision test mathematical function, enabling scalar mathematical function, enabling adaptive timing repetitions to increase speed of testing at the expense of timing accuracy, disabling verification for debugging, enabling exception testing, enabling testing of denormalized numbers, disabling graphing data output, the block size for passing to Mathematica, and a parameter for the adaptive timing repetitions selected.

The following columns have one line per floating-point exponent, and represent a summary of the results for all the test arguments with that exponent. Since this example is for a 2-variable mathematical function, the lines refer to all possible 2nd arguments, with the 1st argument having the given sign and exponent. (For a 1-variable mathematical function, the report would look similar, except that the “x2” columns would not appear.)

The columns of the report shown in FIG. 4 are the sign (+or −) [s], the exponent [exp1], exception summary flags (described below) [flags], the argument at which the maximum observed error occurred in both decimal [max abs ulperr at] and hex [max abs ulperr at (hex)], the maximum absolute error in ulps [max abs ulperr], the maximum rms error in ulps [max rms ulperr], the condition number (not activated in the report) [cond], and the time per call [max time sec/call]. The group of lines above and below 0 row are for denormalized exponents.

The [flags] column contains the exception information. The characters to the left of the “/” refer to the test mathematical function, and those to the right, to the reference mathematical function. The meaning of the symbols are:
<=+INF (+∞)
>=−INF (−∞)
N=NaN (not a number)
Z=zero error (reference mathematical function was 0 but test mathematical function was not 0)
E=empty (no argument with this exponent produced a non-exception function value)
I=inexact (not every result was correctly rounded)
*=the test and reference mathematical function did not agree on an exception result (one returned an exception but the other did not, or it returned a different exception)

The last three lines in the list are for the exception arguments −INF, +INF, and NaN. The line below the “overall statistics” label is a summary for the entire test. The union of all the exception flags and the location and size of the maximum overall error are shown. Following are the minimum and maximum arguments tested and the number of arguments tested (for verification purposes), the average scaled maximum gap and maximum scaled maximum gap between random arguments (for each variable) and the deviation of this from the statistical model as calculated by the argument generation module 110, the minimum and maximum signed ulp errors, and an error histogram. This histogram gives the percent of the test arguments for which the results was correctly rounded (ulp error <=0.5), between 0.5 and 1, between 1 and 2, between 2 and 10, or greater than 10. Finally, there is the minimum, average, and maximum time per call. Calls resulting in exceptions are listed separately.

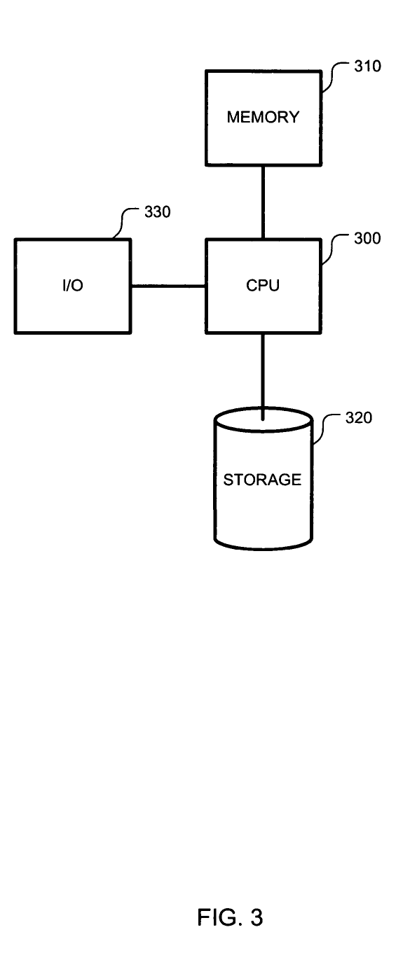

The hardware elements of a computer system used to implement the present invention are shown in FIG. 3. A central processing unit (CPU) 300 provides main processing functionality. A memory 310 is coupled to CPU 300 for providing operational storage of programs and data. Memory 310 may comprise, for example, random access memory (RAM) or read only memory (ROM). Non-volatile storage of, for example, data files and programs is provided by a storage 320 that may comprise, for example, disk storage. Both memory 310 and storage 320 comprise a computer useable medium that may store computer program products in the form of computer readable program code. User input and output is provided by an input/output (I/O) facility 330. The I/O facility 330 may include, for example, a graphical display, a mouse and/or a keyboard.

In summary, an exemplary embodiment of the invention comprises a system and method for systematic random testing of single/double-precision, one/two-variable, scalar/vector mathematical functions. Another exemplary embodiment of the invention comprises a system and method to systematic random testing of mathematical functions across the entire floating-point range or a test interval defined therein, including denormalized numbers with random test arguments appropriately distributed over the test interval is described. Further, in an exemplary embodiment of the invention, by ensuring the density of coverage of random test arguments across the test interval and identifying the exception behavior of a mathematical function, an accurate picture of the performance and accuracy of the mathematical function can be assessed.

Further, in another exemplary embodiment of the present invention, by ensuring that the distribution of random test arguments matches the piecewise- uniform/exponential distribution of floating-point numbers and verifying that the density of coverage of these random arguments is consistent with the density achieved by a statistical model, reliable, representative results can be achieved. A density of randomly generated test arguments adapted to the exponential distribution of floating-point numbers is provided so that no arguments are over or under represented in the test set. In addition, a further exemplary embodiment of the invention can provide statistical analysis of the gap between generated test arguments which serves several purposes. The statistical analysis enables the identification of any potential problems in the test argument generation, provides feedback to guide the choice of testing density and increases confidence in the coverage of the test interval provided by the test arguments.

The results of the test mathematical function can be compared against the results of a reference function from a known higher precision reference mathematical library or to the result of an arbitrary precision mathematical package such as provided by Mathematica™ software by Wolfram Research Inc. ensuring the accuracy of the end result. In an embodiment of the invention, the flexibility to interface with a standard reference mathematical library interface is provided. This interface is utilized when sufficiently accurate reference mathematical functions would otherwise not be available. This situation can exist when no longer-precision mathematical library mathematical function is available (that is, double precision when testing single-precision mathematical functions, or quad-precision when testing double-precision mathematical functions). It can also occur when a longer-precision mathematical function is available but its accuracy on certain sensitive arguments is unknown or suspect.

1. A system of testing and evaluating the accuracy of a mathematical function for use in computer software in relation to a reference mathematical function over a test interval, the system comprising:
an argument generation module for generating a piecewise uniform and overall exponential distribution of random test arguments for each floating-point exponent within the test interval;
computation module interfacing with (i) the mathematical function to obtain a first set of results and with (ii) the reference mathematical function to obtain a second set of results based on the random test arguments generated by the argument generation module; and
an evaluation module for analyzing the first set of results with the second set of results for providing an indication of accuracy of the mathematical function.

2. The system of claim 1, wherein the reference mathematical function is of higher precision relative to the mathematical function.

3. The system of claim 1, wherein the computation module further obtains results for +/−∞ and NaN (Not a Number) exception arguments from the mathematical function and the reference mathematical function.

4. The system of claim 1, wherein the argument generation module determines a gap size between all adjacent pairs of the random test arguments and then compares a maximum gap size and an average gap size to a statistical model.

5. The system of claim 4, wherein the statistical model is defined as:
P(g>x)=(1−e^{-nx})ⁿ, wherein P(g>x) is the probability that the maximum gap size g between adjacent pairs of the random test arguments is greater than x, and n is the number of random test arguments in the test interval.

6. A method of testing and evaluating the accuracy of a mathematical function to a known mathematical function over a test interval, the method comprising:
(a) generating a set of piecewise uniformly and exponentially distributed random test arguments for each floating-point exponent within a test interval;
(b) obtaining a first set of results from the mathematical function using the random test arguments;
(c) obtaining a second set of results from the known mathematical function using the random test arguments; and
(d) comparing said first set of results to said second set of results to determine the accuracy of the mathematical function.

7. The method of claim 6, wherein steps (b) and (c) include obtaining results for +/−∞ and NaN (Not a Number) exception arguments from the mathematical function and the known mathematical function.

8. The method of claim 6, further comprising:
(e) providing an indication of the timing and exception behavior of the mathematical function based on the results obtained at step (b).

9. The method of claim 6, wherein at step (b) the random test arguments are provided in a loop when the mathematical function is a scalar function.

10. The method of claim 6, wherein at step (b) the random test arguments are provided as a vector when the mathematical function is a vector function.

11. The method of claim 6, further comprising:
(f) comparing a gap size between adjacent pairs of the random test arguments to a statistical model.

12. The method of claim 11, wherein the statistical model is defined as
P(g>x)=(1−e^{-nx})ⁿ, wherein P(g>x) is the probability that the maximum gap size g between adjacent pairs of the random test arguments is greater than x, and n is the number of random test arguments in the test interval.

13. A computer-readable medium having computer-executable instructions for performing the steps comprising:
(a) generating a set of piecewise uniformly and exponentially distributed random test arguments for each floating-point exponent within a test interval;
(b) obtaining a first set of results from a mathematical function using the random test arguments;
(c) obtaining a second set of results from a known mathematical function using the random test arguments; and
(d) comparing said first set of results to said second set of results to determine the accuracy of the mathematical function.

14. The computer readable medium of claim 13 wherein steps (b) and (c) include obtaining results for +/−∞ and NaN (Not a Number) exception arguments from the mathematical function and the known mathematical function.

15. The computer readable medium of claim 13, further comprising:
(e) providing an indication of the timing and exception behavior of the mathematical function based on the results obtained at step (b).

16. The computer readable medium of claim 13, wherein at step (b) the random test arguments are provided in a loop when the mathematical function is a scalar function.

17. The computer readable medium of claim 13, wherein at step (b) the random test arguments are provided as a vector when the mathematical function is a vector function.

18. The computer readable medium of claim 13, further comprising:
(f) comparing a gap size between adjacent pairs or random test arguments to a statistical model.

19. The computer readable medium of claim 13, wherein the statistical model is defined as,
P(g>x)=(1−e^{-nx})ⁿ, wherein P(g>x) is the probability that the maximum gap size g between adjacent pairs of the random test arguments is greater than x, and n is the number of random test arguments in the test interval.
